(19) United States
(12) Patent Application Publication
(10) Pub. No.: US 2024/0344707 A1
(43) Pub. Date: Oct. 17, 2024

(54) HEATING COOKER

(71) Applicant: Panasonic Intellectual Property Management Co., Ltd., Osaka (JP)

(72) Inventors: RYOSUKE OTANI, Shiga (JP); TAKAHIRO HAYASHI, Shiga (JP); DAISUKE YASUKOCHI, Shiga (JP)

(21) Appl. No.: 18/579,657

(22) PCT Filed: Sep. 20, 2022
(86) PCT No.: PCT/JP2022/034882

§ 371 Date: Jan. 16, 2024

(30) Foreign Application Priority Data
Oct. 4, 2021 (JP) 2021-163188

(51) Int. Cl. F24C 7/02; F24C 15/02

(52) U.S. Cl. CPC F24C 7/02; F24C 15/028

(57) ABSTRACT

A cooker in accordance with the present disclosure is provided with a body, a heating chamber, a microwave heating mechanism, and a door. The heating chamber is provided inside the body, and includes a bottom wall and a side wall. The microwave heating mechanism emits microwave to the heating chamber. The door is attached to the body to cover an opening of the heating chamber. The heating chamber further includes a bottom plate that is disposed above the bottom wall and separated from the side wall by a gap, and a side plate that is disposed on an inner surface of the heating chamber of the side wall to cover the gap and a part of the bottom plate.

### TECHNICAL FIELD

The present disclosure relates to a cooker.

### BACKGROUND ART

In the conventional cooker, a gap between a side wall and a bottom wall of a heat chamber is filled with adhesive glue or the like to prevent steam, waterdrop, oil content, and the like, which are generated in the heat chamber, from leaking out of the heat chamber (see Patent Literature 1).

### CITATION LIST

### Patent Literature

PTL 1: Unexamined Japanese Patent Publication No. 2020-139707

### SUMMARY OF THE INVENTION

In the conventional cooker, there is still room for improvement in the viewpoint of collecting waterdrop, oil content, and the like, which are generated in the heating chamber, in a bottom plate of a heating chamber efficiently.

The present disclosure aims to provide a cooker capable of collecting waterdrop, oil content, and the like, which are generated in the heating chamber, in the bottom plate of the heating chamber efficiently.

A cooker in accordance with one aspect of the present disclosure is provided with a body, a heating chamber, a microwave heating mechanism, and a door. The heating chamber, which is provided inside the body, includes a bottom wall and a side wall. The microwave heating mechanism emits microwave to the heating chamber. The door is attached to the body to cover an opening of the heating chamber. The heating chamber further includes a bottom plate that is disposed above the bottom wall and separated from the side wall by a gap, and a side plate that is disposed on an inner surface of the heating chamber of the side wall to cover the gap and a part of the bottom plate.

According to the present disclosure, waterdrop, oil content, and the like, which are generated in the heating chamber, can efficiently be collected in the bottom plate of the heating chamber.

### BRIEF DESCRIPTION OF DRAWINGS

FIG. 1 is a front perspective view of a cooker in accordance with an exemplary embodiment of the present disclosure.

FIG. 2 is a front perspective view of the cooker in accordance with the exemplary embodiment in the state where a door is opened.

FIG. 3 is a front view of the cooker in accordance with the exemplary embodiment in the state where the door is opened.

FIG. 4 is a vertical cross-sectional view of the front center of the cooker in accordance with the exemplary embodiment in the state where the door is closed.

FIG. 5 is a partial cross-sectional view showing a flow of circulating air inside the cooker in accordance with the exemplary embodiment in the state where the door is closed.

FIG. 6 is a partially enlarged cross-sectional view of the cooker in accordance with the exemplary embodiment.

FIG. 7 is a partially enlarged perspective view of the cooker in accordance with the exemplary embodiment.

### DESCRIPTION OF EMBODIMENT(S)

### (Knowledge Used as Foundation of Present Disclosure)

The inventors of the present application have made extensive studied to collect waterdrop, oil content, and the like, which are generated in a heating chamber, in a bottom plate of the heating chamber efficiently. As the result, they have obtained the following knowledge.

In the conventional cooker, a gap between a side wall and a bottom wall of the heating chamber is filled with adhesive glue or the like to prevent steam, waterdrop, oil content, and the like, which are generated in the heating chamber, from leaking out of the heating chamber.

However, if a bottom plate, which can withstand heating by a 1500W high-power heater and a high-power microwave, is installed above the bottom wall of the heating chamber, a gap may be generated between the bottom plate and the side wall of the heating chamber. If waterdrop, oil content, food scraps, and the like enter this gap, the cleaning will be made difficult to cause hygienic problems.

If the gap between the bottom plate and the side wall of the heating chamber is covered with a side plate, waterdrop, oil content, and the like, which are generated in the heating chamber, can efficiently be collected in the bottom plate of the heating chamber. As a result, waterdrop, oil content, food scraps, and the like can be prevented from entering this gap, thereby making it possible to reduce time and effort for a user to clean it. Based on this knowledge, the inventors of the present application have reached the following invention.

A cooker in accordance with a first aspect of the present disclosure is provided with a body, a heating chamber, a microwave heating mechanism, and a door. The heating chamber, which is provided inside the body, includes a bottom wall and a side wall. The microwave heating mechanism emits microwave to the heating chamber. The door is attached to the body to cover an opening of the heating chamber. The heating chamber further includes a bottom plate that is disposed above the bottom wall and separated from the side wall by a gap, and a side plate that is disposed on an inner surface of the heating chamber of the side wall to cover the gap and a part of the bottom plate.

According to the aspect, waterdrop, oil content, and the like, which are generated in the heating chamber, can efficiently be collected in the bottom plate of the heating chamber from the side plate of the heating chamber. Waterdrop, oil content, food scraps, and the like can be prevented from entering this gap, thereby making it possible to reduce time and effort for a user to clean it.

In a cooker in accordance with a second aspect of the present disclosure, in addition to the first aspect, the side plate includes a first inclination portion provided in a lower end part of the side plate, and the bottom plate includes a second inclination portion provided in an end part of the bottom plate facing the gap. Herein, the first inclination portion is in contact with the second inclination portion so as to cover the gap.

According to this aspect, waterdrop, oil content, and the like, which are generated in the heating chamber, can efficiently be collected in the bottom plate of the heating chamber from the inclined end portion of the side plate in the heating chamber. Waterdrop, oil content, food scraps, and the like can be prevented from entering this gap, thereby making it possible to reduce time and effort for a user to clean it.

In a cooker in accordance with a third aspect of the present disclosure, the bottom plate further includes a recessed portion provided in an upper face thereof, in addition to the first aspect or the second aspect.

According to this aspect, waterdrop, oil content, and the like, which are generated in the heating chamber, can be collected into the recessed portion provided in the upper face of the bottom plate in the heating chamber from the side plate of the heating chamber, thereby making it possible to reduce time and effort for a user to clean it.

In addition to the third aspect, a cooker in accordance with a fourth aspect of the present disclosure is further provided with a placing table having a leg that can be placed in the recessed portion.

According to this aspect, waterdrop, oil content, and the like, which are generated from a heating target, can efficiently be collected into the recessed portion of the bottom plate from the placing table, thereby making it possible to reduce time and effort for a user to clean it.

### Exemplary Embodiment

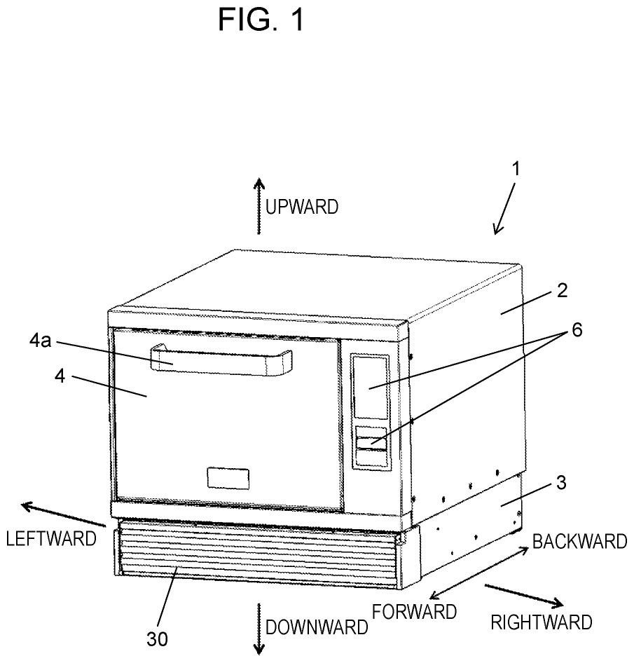

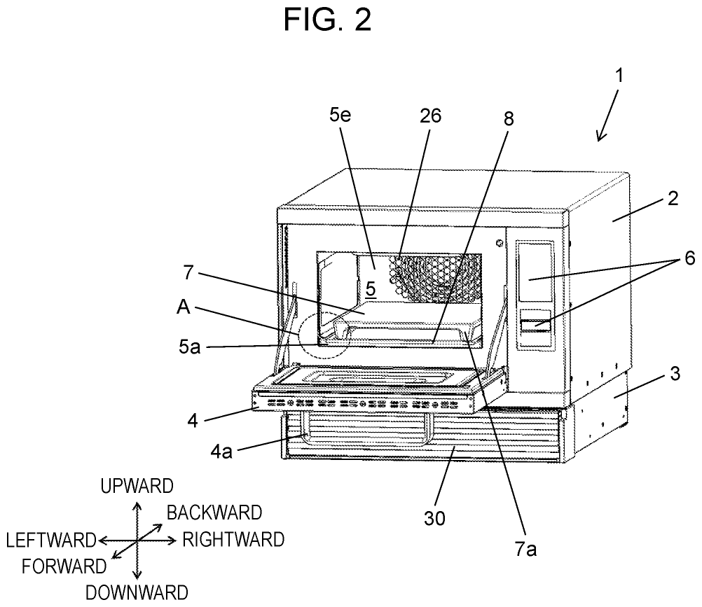

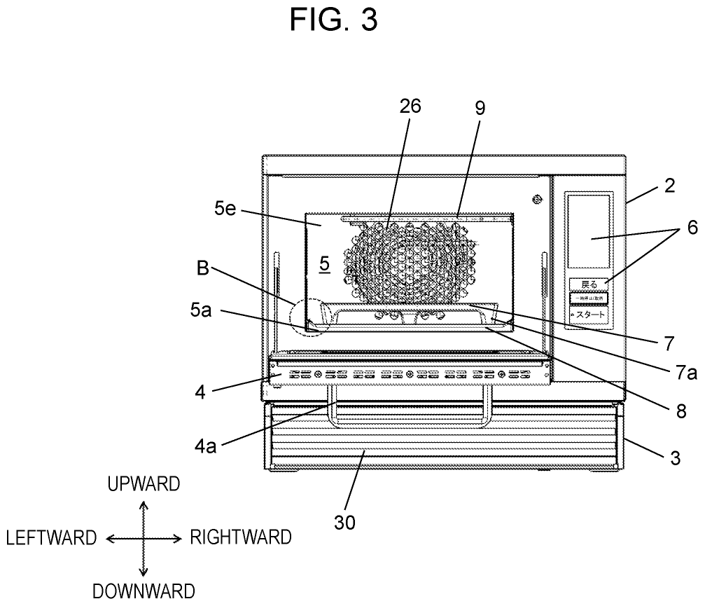

Hereinafter, cooker 1 in accordance with an exemplary embodiment of the present disclosure will be described with reference to the drawings. FIG. 1 is a front perspective view of cooker 1 in the state where door 4 is closed. FIG. 2 is a front perspective view of cooker 1 in the state where door 4 is opened. FIG. 3 is a front view of cooker 1 in the state where door 4 is opened.

In the present exemplary embodiment, as shown in each view, the vertical upper side is defined as an upward direction, a direction opposite to the upward direction is defined as a downward direction, and the right side and the left side of cooker 1 when viewed from a user are defined as a rightward direction and a leftward direction, respectively. When a user uses the cooker, a user side of cooker 1 is defined as a forward direction of cooker 1, and a direction opposite to the forward direction is defined as a backward direction of cooker 1.

In the present exemplary embodiment, cooker 1 is a cooker for business use, i.e., a high-power cooker used in a convenience store, a fast-food restaurant, or the like. Of course, the present disclosure is also applicable to a cooker for home use. According to a cooking content, cooker 1 performs any of microwave heating, radiation heating, and hot-air circulation heating independently, or performs at least two of these sequentially or simultaneously.

As shown in FIGS. 1 through 3, cooker 1 is provided with body 2, heating chamber 5, machine room 3, and door 4. Heating chamber 5 is provided inside body 2. Machine room 3 is disposed under heating chamber 5 in body 2. Door 4 is disposed in a front face of body 2 to cover an opening located in the front of heating chamber 5.

Door 4 has handle 4a. When a user pulls handle 4a in the forward direction, door 4 is pivoted about a hinge, which is provided on both sides in a lower part thereof, and opened. In the front face of body 2, there is provided operation display 6 that displays setting operation, setting content, or the like for cooker 1 through a user. Detachable ventilation panel 30 is disposed in a front face of machine room 3.

In the state where door 4 is closed (see FIG. 1), heating by microwave or the like is applied to a heating target in heating chamber 5. In the state where door 4 is opened (see FIG. 2), a heating target is accommodated in heating chamber 5, or taken out from heating chamber 5.

Heating chamber 5 of body 2 is provided with a space of a substantially rectangular parallelepiped shape that includes an opening in the front thereof. Door 4 covers the opening in the front to seal heating chamber 5, so that a heating target to be cooked by heating is accommodated in heating chamber 5. In this state, at least one of a hot-air circulation heating mechanism, a radiation heating mechanism, or a microwave heating mechanism is used to cook the heating target by heating.

The hot-air circulation heating mechanism is disposed behind heating chamber 5 and near a top face of heating chamber 5. The radiation heating mechanism is disposed near the top face of heating chamber 5. The microwave heating mechanism is disposed under bottom wall 5a of heating chamber 5. Bottom wall 5a of heating chamber 5 is made of a material through which microwave easily passes, such as glass or a ceramic, for example.

Inside heating chamber 5, placing table 7 and bottom plate 8 can be accommodated. Placing table 7 is used to place a heating target, and bottom plate 8 is disposed under placing table 7 to receive fat dripping from the heating target or the like.

Placing table 7 can be detached out of heating chamber 5. Placing table 7 is constituted by a ceramic table, for example. Placing table 7 is integrally formed by a plate-like member capable of placing a heating target thereon and four legs 7a for supporting the plate-like member. Legs 7a are placed on bottom plate 8. The bottom plate 8 is fixed to an upper face of bottom wall 5a of heating chamber 5.

Bottom plate 8 and placing table 7 are made of ceramic, specifically made of cordierite (cordierite). The cordierite is a ceramic consisting of magnesium oxide, aluminum oxide, and silicon oxide, and has characteristics of low thermal expansion and excellent thermal shock resistance. Accordingly, if microwave concentrates on a surface of placing table 7, and even if a heating target is heated at a high temperature of 300° C. or more, there will be no problem in the safety of placing table 7.

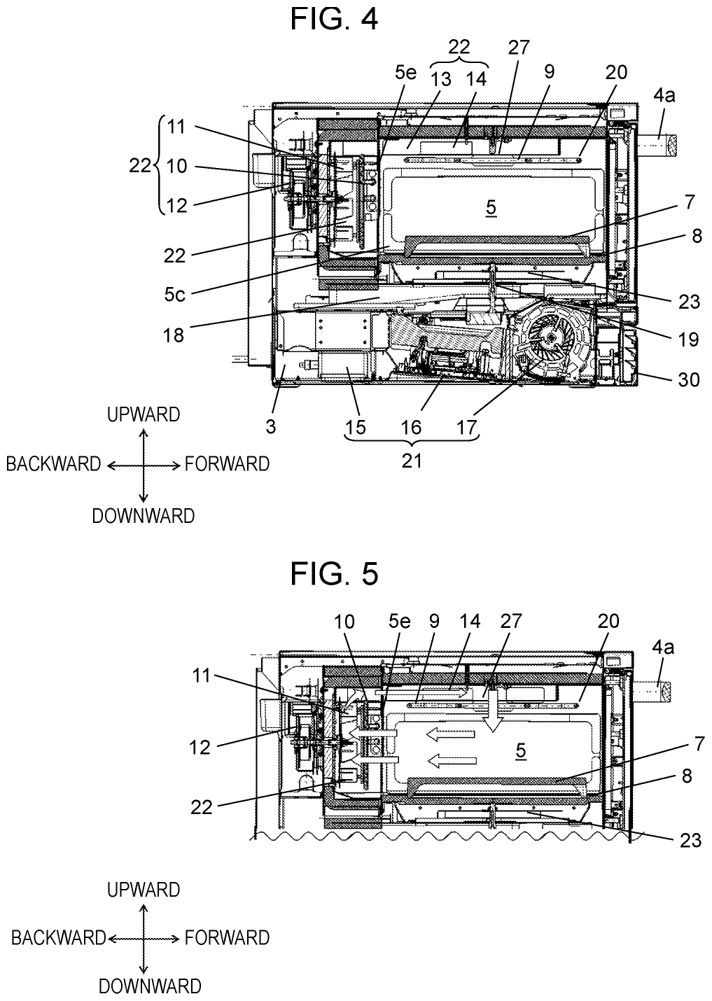

FIG. 4 is a vertical cross-sectional view of a front center part of cooker 1 in the state where door 4 is closed. FIG. 5 is a partial cross-sectional view showing a flow of circulating air inside the cooker in the state where door 4 is closed. In FIGS. 4 and 5, the right side indicates the forward direction of cooker 1.

As shown in FIGS. 4 and 5, grill heater 9, which constitutes radiation heating portion 20, is disposed near the top face of heating chamber 5. Grill heater 9 is constituted by one sheath heater that is disposed near the top face and has a bent shape. Grill heater 9 is used in a grill mode (radiation heating) in which a heating target is cooked by heating using radiant heat.

As shown in FIG. 4, microwave heating portion 21 is disposed inside machine room 3. Microwave heating portion 21 includes magnetron 15, inverter 16, and cooling fan 17. Microwave heating portion 21 is controlled by a controller (not shown).

The magnetron generates microwave. Inverter 16 drives magnetron 15. Cooling fan 17 inhales air from ventilation panel 30, which is provided in the front face of machine room 3, and sends out the inhaled air to the back side. The air cools inverter 16, magnetron 15, and the like which are disposed inside machine room 3.

Microwave heating portion 21 includes waveguide 18 and microwave supply portion 19. Waveguide 18 guides the microwave, which is generated by magnetron 15, to below the center part of heating chamber 5. The microwave supply portion 19 is an opening that is disposed below the center part of heating chamber 5 and formed in an upper face of an end part of waveguide 18. Microwave supply portion 19 emits the microwave, which is guided by the waveguide 18, to the inside of heating chamber 5.

To stir the microwave emitted from microwave supply portion 19, stirrer (stirrer) 23 is disposed above microwave supply portion 19. Stirrer 23, which is driven by a stirrer driver (not shown), includes a blade for stirring the microwave emitted from microwave supply portion 19. The stirrer driver is a motor disposed inside machine room 3.

Accordingly, in cooker 1, the stirred microwave is emitted to the inside of heating chamber 5 from under heating chamber 5, so that a heating target placed on placing table 7 is heated.

As shown in FIGS. 4 and 5, cooker 1 is provided with hot-air generation mechanism 22, in addition to radiation heating portion 20 and microwave heating portion 21. Hot-air generation mechanism 22 is controlled by a controller (not shown) including a microcomputer. Hot-air generation mechanism 22, which is disposed inside body 2 and behind heating chamber 5, includes convection heater 10, circulation fan 11, and fan driver 12.

Convection heater 10 is a heat source for hot-air circulation heating. Circulation fan 11 is an air blowing source. Fan driver 12 is a motor for driving circulation fan 11. As shown in FIGS. 2 and 3, a plurality of holes 26 are formed in back wall 5e of heating chamber 5.

When circulation fan 11 is operated, the air in heating chamber 5 is inhaled through holes 26 and reaches hot-air generation mechanism 22. In hot-air generation mechanism 22, the air is converted into hot air through convection heater 10 and circulation fan 11. The hot air is blown out to the inside of heating chamber 5 from air outlet 27 provided in a bottom face of flow passage forming portion 13. Outline arrows in FIG. 5 indicate a flow of the air inside cooker 1.

Hot-air generation mechanism 22 includes flow passage forming portion 13 and air flow guide 14, which are described later. Flow passage forming portion 13 and air flow guide 14, which are disposed near the top face of heating chamber 5, specify a flow velocity and a blowing direction of the air flowing from air outlet 27 to heating chamber 5.

Flow passage forming portion 13 and air flow guide 14 are disposed in a part above heating chamber 5 to form a space above heating chamber 5, thereby specifying the flow velocity and the blowing direction of the air that flows inside the above space and is blown out to heating chamber 5.

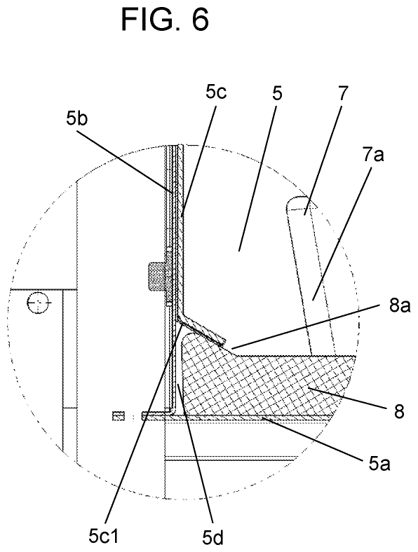

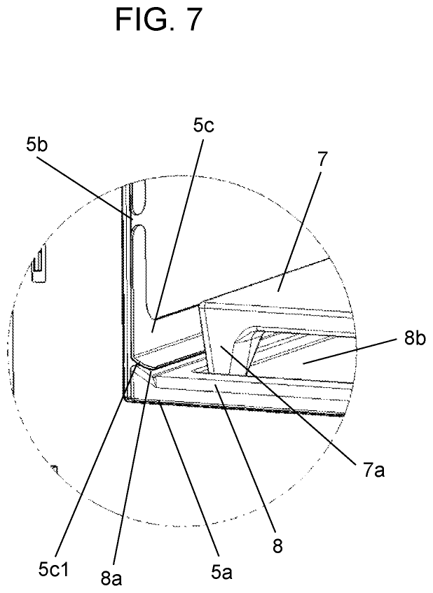

Next, the structure of bottom wall 5a and side wall 5b in a lower left corner and a lower right corner of heating chamber 5 will be described. FIG. 6 is an enlarged cross-sectional view of B portion (see FIG. 3) in FIG. 3. FIG. 7 is an enlarged perspective view of A portion (see FIG. 2) in FIG. 2.

As shown in FIGS. 6 and 7, bottom plate 8 is fixed on bottom wall 5a of heating chamber 5. As a method of fixing bottom plate 8, welding may be used, or adhesion by adhesives may be used, for example. Second inclination portion 8a, which bulges upward from bottom plate 8 toward side plate 5c, is formed in right and left end parts (in FIGS. 6 and 7, only a left end part is shown) of bottom plate 8.

Side plate 5c is fixed to an inner surface of heating chamber 5 on side wall 5b of heating chamber 5. A lower end part of side plate 5c is bent to an inner side of heating chamber 5 to form first inclination portion 5cl. As a method of fixing side plate 5c to side wall 5b, adhesion or welding, or a bolt and a nut may be used to perform the fixing. If a fluoride-coated plate material, which is made of stainless steel, is used for side plate 5c, dirt will hardly adhere to side plate 5c. Even if dirt adheres to side plate 5c, a user can easily clean it.

Gap 5d exists between side wall 5b and bottom plate 8, as shown in FIG. 6. First inclination portion 5cl and second inclination portion 8a are in contact with each other such that first inclination portion 5cl covers over second inclination portion 8a. In this way, first inclination portion 5cl covers gap 5d and the right and left end parts of bottom plate 8.

Besides the above-mentioned method, the lower end part of side plate 5c, which is bent perpendicularly, may be brought into contact with a top part of bottom plate 8 to cover gap 5d and the end parts of bottom plate 8.

With such structure, waterdrop, oil content, and the like, which are generated in heating chamber 5, can efficiently be collected in bottom plate 8 of heating chamber 5 from side plate 5c of heating chamber 5. Thus, waterdrop, oil content, food scraps, and the like can be prevented from entering gap 5d, thereby making it possible to reduce time and effort for a user to clean it.

Furthermore, bottom plate 8 is provided with recessed portion 8b that is formed in an upper face thereof, as shown in FIG. 7. With this structure, waterdrop, oil content, and the like, which are generated in the heating chamber, can efficiently be collected into recessed portion 8b of bottom plate 8 in heating chamber 5 from side plate 5c of heating chamber 5, thereby making it possible to reduce time and effort for a user to clean it.

Placing table 7 has four legs 7a that can be placed in recessed portion 8b of bottom plate 8. With this structure, waterdrop, oil content, and the like, which are generated from a heating target, can efficiently be collected into recessed portion 8b of bottom plate 8 from placing table 7, thereby making it possible to reduce time and effort for a user to clean it.

Further, if four legs 7a each are disposed so as to be brought into contact with a corresponding one of four corners of recessed portion 8b, placing table 7 can be positioned easily. As long as placing table 7 is placed in recessed portion 8b of bottom plate 8, the number of legs 7a may be a number other than four.

Note that, in the present exemplary embodiment, the structure of the lower right corner of heating chamber 5 is the same as that of the lower left corner thereof. However, these corners may have different structures from each other.

### INDUSTRIAL APPLICABILITY

The present disclosure is applicable to a microwave oven, a toaster oven, and the like, for example.

### REFERENCE MARKS IN THE DRAWINGS

1 cooker
2 body
3 machine room
4 door
4a handle
5 heating chamber
5a bottom wall
5b side wall
5c side plate
5cl first inclination portion
5d gap
5e back wall
6 operation display
7 placing table
7a leg
8 bottom plate
8a second inclination portion
8b recessed portion
9 grill heater
10 convection heater
11 circulation fan
12 fan driver
13 flow passage forming portion
14 air flow guide
15 magnetron
16 inverter
17 cooling fan
18 waveguide
19 microwave supply portion
20 radiation heating portion
21 microwave heating portion
22 hot-air generation mechanism
23 stirrer
26 hole
27 air outlet
30 ventilation panel

1. A cooker comprising:
a body;
a heating chamber that includes a bottom wall and a side wall, the heating chamber being provided inside the body;
a microwave heating mechanism that is configured to emit microwave to the heating chamber; and
a door that is attached to the body to cover an opening of the heating chamber,
wherein
the heating chamber further includes
a bottom plate that is disposed above the bottom wall and separated from the side wall by a gap, and
a side plate that is disposed on an inner surface of the heating chamber of the side wall to cover the gap and a part of the bottom plate.

2. The cooker according to claim 1, wherein
the side plate includes a first inclination portion provided in a lower end part of the side plate,
the bottom plate includes a second inclination portion provided in an end part of the bottom plate facing the gap, and
the first inclination portion is in contact with the second inclination portion so as to cover the gap.

3. The cooker according to claim 1, wherein
the bottom plate further includes a recessed portion provided in an upper face of the bottom plate.

4. The cooker according to claim 3, further comprising
a placing table that includes a leg allowed to be placed in the recessed portion.
